(19) United States
(12) Patent Application Publication
(10) Pub. No.: US 2021/0003112 A1
(43) Pub. Date: Jan. 7, 2021

(54) Bamboo wind turbine

(71) Applicant: Marc Gregory Allinson, Kingsville, MD (US)

(72) Inventor: Marc Gregory Allinson, Kingsville, MD (US)

(21) Appl. No.: 16/873,098

(22) Filed: Jan. 29, 2020

Related U.S. Application Data
(60) Provisional application No. 62/765,777, filed on Nov. 29, 2018.

(51) Int. Cl. F03D 3/00; F03D 80/70; F03D 9/25

(52) U.S. Cl. CPC F03D 3/005; F03D 9/25; F03D 80/70

(57) ABSTRACT

The present invention relates to a novel way of manufacturing and assembling wind turbines to harness energy from wind. Chiefly, the invention is a way to build a darrieus vertical axis wind turbine and eliminate the need for a tower. This is done by using greater than two blades, replacing the tower with high tension cable(s) and adding high tension cables to the circumference of the turbine attached to each blade. This prevents deformation, reduces weight, and makes a rigid structure using tension and compression. Furthermore, this turbine can be built from whole bamboo poles and includes blades composed of whole bamboo poles, cables, and architectural fabric/membranes/composites. The invention includes unique applications for the turbine such as floating and ground-based systems and has custom bearings, foundations, passive cooling, manufacturing, and brakes. There is also a method of generating low pressure downstream of the turbines using a jib sail like structure. There is a collapsible frame system used for quickly erecting and assembling the turbines in the field.

### CROSS REFERENCE

This Invention, Bamboo Wind Turbine, claims the filing date of provisional patent 62/765,777 with priority filing date Nov. 29, 2018.

### SPECIFICATION

### Technical Field

The present invention relates to a novel way of manufacturing, shipping, installing, and assembling wind turbines to harness energy from wind.

### Background of the Invention

With the increased price of energy and the need for clean sources of energy wind turbines are necessary and growing quickly in popularity and deployment. The present invention utilizes material science, automated manufacturing, and the venturi effect to harness energy from wind.

### BRIEF SUMMARY OF THE INVENTION

The present invention relates to a novel way of manufacturing and assembling wind turbines to harness energy from wind. Chiefly, the invention is a way to build a darrieus vertical axis wind turbine and eliminate the need for a tower. This is done by using greater than two blades, replacing the tower with high tension cable(s) and adding high tension cables to the circumference of the turbine attached to each blade. This prevents deformation, reduces weight, and makes a rigid structure using tension and compression. Furthermore, this turbine can be built from whole bamboo poles and includes blades composed of whole bamboo poles, cables, and architectural fabric/membranes/composites. The invention includes unique applications for the turbine such as floating and ground-based systems and has custom bearings, foundations, passive cooling, manufacturing, and brakes. There is also a method of generating low pressure downstream of the turbines using a jib sail like structure. There is a collapsible frame system used for quickly erecting and assembling the turbines in the field.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 comprises an embodiment of the invention comprising the tension compression tower-less vertical axis wind turbine with a ring type permanent magnet generator hung from the blades and a monopole foundation.

FIG. 2A comprises a side view of the compression and tension forces acting on the blades of the wind turbine forming a ridged structure without the need of a tower. The image does not show the blade membrane but shows the frame structure forming the blades and turbine structure. The steel cable running the length of the interior of the blade frame bamboo poles, multiple poles the length of the blades, and a material wrapping the poles at their ends that the meet additional poles.

FIG. 2B comprises a top view of the compression and tension forces acting on the blades of the wind turbine forming a ridged structure without the need of a tower. The image does not show the blade membrane but shows the frame structure forming the blades and turbine structure. This system allows for variation of the width of the blades by adjusting the relative angle and position of the blade frame poles. This system can also have more than three blades.

FIG. 3A comprises a cross section of the turbine showing the central compression cable and the circumferential tension cable as well as frame poles comprising the blades. The diameter of the frame poles is variable in this depiction as a membrane can encapsulate the frame to make an airfoil. By adjusting the diameters of the poles, the airfoil shape can be changed.

FIG. 3B depicts a cross section of the blades with variable pole diameters also shown is a relative position of the steel cable running the interior length of the blade frame poles.

FIG. 4 comprises a method of joining bamboo poles using a sleeve the sleeve in this picture is comprised of bamboo with a glue between the sleeve and the interior poles. The sleeve in this picture is further wrapped in steel or other cables to reinforce the sleeve.

FIG. 5 comprises a bamboo monopole comprised of multiple strings of bamboo poles staggered and bound together.

FIG. 6 comprises an image of the turbine with three segment blade frame poles sleeves wrapping the blade frame poles cables running the interior length of the blade frame poles. A flush attachment point at the top and bottom of the turbine. Central compression cable and circumferential tension cables wrapped around the turbine.

FIG. 7 comprises an image of the turbine with three segment blade frame poles sleeves wrapping the blade frame poles. A flush attachment point at the top and bottom of the turbine. This image comprises an attachment system that does not require a cable to run the length of the blade from poles. Central compression cable and circumferential tension cables are wrapped around the turbine.

FIG. 8 comprises an image of the turbine with three segment blade frame poles sleeves wrapping the blade frame poles. A flush attachment point at the top and bottom of the turbine. This image comprises an attachment system that does not require a cable to run the length of the blade from poles. Central compression cable and circumferential cables are wrapped around the turbine. The number of central compression cables and circumferential tension cables are variable and attached at variable points.

FIG. 9A comprises an image of the turbine with an attachment method where there are channels through the bearing male pieces so the cables running the interior length of the blade frame poles can attach to the bearing male pieces and the poles remain flush.

FIG. 9B comprises an image of the turbine with the blade frame poles composed of multiple bamboo pole segments and sleeves in this method providing a way to make the blades longer.

FIG. 10 comprises blade frame poles with and without the blade membrane forming a turbine blade.

FIG. 11 comprises three blades and top and bottom male and female piece bearings.

FIG. 12 comprises a side view of a configuration of the tension structure where the blades are two lengths of bamboo poles long.

FIG. 13 comprises a side view of a configuration of the tension structure where the blades are three lengths of bamboo poles long.

FIG. 14 comprises a side view of a configuration of the tension structure where the blades are six lengths of bamboo poles long and does not require a top bearing.

FIG. 15 comprises a configuration using roller bearings nested into the top of the monopole referenced in FIG. 5.

FIG. 16 comprises a configuration a top and bottom plain bearing. Depicted in the figure is a method of attaching blade frame poles to the bearings.

FIG. 17 comprises a resin bearing female piece.

FIG. 18 comprises a male piece for a plain bearing.

FIG. 19 comprises a top view of the turbine's generator showing a potential attachment configuration for the generator rotor and at the center a plate fitted between the blade frame poles. The plate is an eddy current plate for an electromagnetic brake.

FIG. 20 comprises a side view of the turbine's generator. Depicted the bamboo blade pole attachment to a bearing nested in a bamboo monopole as depicted in FIG. 5. The stator is resting on and staked to the ground and the rotor is hanging from the blades. The Steel cables from which the rotor are hung are nested in bamboo to prevent deformation. Furthermore, an electromagnetic brake is depicted with the eddy plate mounted between the blade frame poles and the induction current generators mounted on a frame staked to the ground with the stator.

FIG. 21, comprises a method of making a ring from individual bamboo segments with steel cable inside the ring.

FIG. 22, comprises a top view of the relative shape of the point that blade frame bamboo poles attach to the bearing male pieces. Displayed in the image are positions of the blade poles with attachment cables and the embedded heat sticks.

FIG. 23, comprises a bamboo piling filled with concrete and a steel pile driver hammer target inserted above the concrete.

FIG. 24 comprises a bearing nested into the monopole noted to FIG. 5. The bearing in FIG. 24 has channels drilled through the male piece for cables to pass so blade frame poles ban be flush attached and space for the cables to be tied or fastened. Additionally, a gasket is present to create a movable but semi-sealed surface between the male and female piece. The female piece has a lip that rests on the poles in the monopole referenced FIG. 5 than can extend to rest on additional materials to distribute the weight of the system.

FIG. 25A comprises a top view of the female piece bearing referenced in FIG. 24

FIG. 25B comprises a top view of the generator stator staked into the ground with cross support framework. Attached to the cross-support framework are induction generators for the electromagnetic brake.

FIG. 26 comprises a top view of an array of wind turbines. Each turbine is depicted by a circle attachment guidewire are shown with three anchor points. This decreases the number of peripheral anchor point needed per turbine.

FIG. 27 comprises a turbine blade configuration with three blade frame poles a cross struts.

FIG. 28 comprises a side view of a male piece bearing with heat sticks embedded into the bearing and a heat sink attached to the heat sticks.

FIG. 29 comprises a side view of a male piece bearing with enlarged attachment channels and an aerodynamic attachment to act as an induction pump while the turbine spins. The pump can pull air through and across the attachment cables running the length of the blade frame poles. The attachment cables can act as a heat sink and this system act as a passive cooling system for the bearings.

FIG. 30 comprises the turbine with a jib sail attached to the turbine. The jib sail acts as a nozzle to form a low-pressure zone behind the turbine.

FIG. 31 comprises a wind farm with multiple embodiments of the turbine.

FIG. 32 comprises the turbine with variable generator type and a system for controlling the placement of the jib sail on land:

FIG. 33A comprises a side view of an embodiment of the turbine that is integrated with housing.

FIG. 33B comprises a top view of an embodiment of the turbine that is referenced in FIG. 33A.

FIG. 34 comprises a monopole referenced in FIG. 5 with a jib sail attached and an earth anchor cantilever system foundation.

FIG. 35A Comprises an embodiment of the turbine depicting a way that it can be raised without a turbine and lowered during storms.

FIG. 35B Comprises an embodiment of the turbine depicting a way that it can be collapsed.

FIG. 36 comprises a side view of an embodiment of the turbine.

FIG. 37 comprises a front view of an embodiment of the turbine.

FIG. 38A comprises a top view of a wind farm orientation arrows displaying rotation direction. Jib sails are attached to optimize low pressure zone formation. This configuration is best suited for floating wind farms as it can act like a wind sock and self-direction a floating platform to the optimal wind direction.

FIG. 38B comprises a front view of the turbine embodiment references in FIG. 38B. In this embodiment there are two turbines on a floating platform.

FIG. 39 comprises a top view of the turbine references in FIGS. 38A and 38B. Additionally FIG. 39 has two building structures on the turbine located above and below. The structures house people, farming, solar, and wave generators, and hydro turbines.

FIG. 40A comprises a side view of a floating wind turbine platform.

FIG. 40B comprises a front view of a floating wind turbine platform.

FIG. 41A comprises a top view of a floating wind turbine platform.

FIG. 41B comprises a top view of a floating wind turbine platform.

FIG. 42 comprises a jib sail made from steel cable chicken wire and resin.

FIG. 43 comprises a top view of a floating wind farm platform.

FIG. 44A comprises a front view of an embodiment of the invention with two single bearing turbines and one multi bearing and multi generator turbine at the center.

FIG. 45 comprises a front view of an embodiment of the turbine.

FIG. 46A comprises a front view of an embodiment of the turbine.

FIG. 46B comprise front view of three embodiments of the turbine.

FIG. 47A comprises a cross section view of the turbine depicted in FIG. 46A

FIG. 47B comprises a view of a blade frame used in the turbine shown in 47A.

FIG. 48 comprises a view of a blade from made of bamboo with joining of multiple poles using other bamboo poles nested inside and as sleeves.

FIG. 50A comprises a cross section view of an embodiment of a bamboo blade frame airfoil for a wind turbine.

FIG. 50B comprises a view of an embodiment of a bamboo blade frame airfoil for a wind turbine.

FIG. 51A comprises a front view of a system for processing bamboo poles for wind turbines. The poles can be filled with preservative then dried in position.

FIG. 51B comprises a top view of a bamboo pole processing system. There is a pond for soaking bamboo poles in preservative, there is greenhouse with pilings driven into the earth to act as molds for drying bamboo poles into shape. High tension cables prevent the piling tops from deforming.

FIG. 52A comprises an embodiment of the turbine mounted on top of the monopole referenced in FIG. 5. This turbine does not require a top bearing and can be mounted on a tower directly on the ground or on a floating platform.

FIG. 52B comprises the turbine reference in FIG. 52A with membrane on the blade frames.

FIG. 53 comprises a wind turbine bearing mounted inside the monopole referenced in FIG. 5.

FIG. 54 comprises a cross section of an embodiment of the turbine.

FIG. 55A comprises a machine that can automatically assemble the turbines built from bamboo poles.

FIG. 55B comprises a method for raising turbines.

FIG. 56 comprises a top to view of a wind farm array circle representing wind turbines that are connected using guide wires.

FIG. 57A comprises a front view of an embodiment of the turbine in a wind farm.

FIG. 57B comprises a front view of an embodiment of the turbine in a wind farm with a system to adjust the relative position of jib sails attached to towers.

FIG. 58 comprises a front view of an embodiment of the turbine in an array.

FIG. 59A comprises an embodiment of the turbine with a skin around a lattice tower and a multi piling foundation. Furthermore, the pilings extend out of the earth to form a simple bearing for the jib sail to rotate on. A cable circles the foundation and a lip is located at the top of the tower to form a second bearing for the jib.

FIG. 59B comprises a top view of a wind farm array depicting a system for changing the position of jib sails. Wind direction lines are depicted at the top of the image and turbine spin direction arrows located on the circles representing turbines.

FIG. 59C comprises a top view of constrictions constriction between a jib sail and a turbine tower. Wind lines are depicted as well.

FIG. 60A comprises a top view of a wind farm array. Circles represent sample relative positions of ground-based turbines and tower-based turbines can also be located at any guide wire axis point.

FIG. 60A comprises a top view of a wind farm array tower-based turbines are located at guide wire axis points with jib sails attached.

FIG. 61 Figure comprises an embodiment of the turbine

FIG. 62 FIG. 62 comprises an embodiment of the turbine that is more than two bladed floating and is made from materials bamboo and/or other materials.

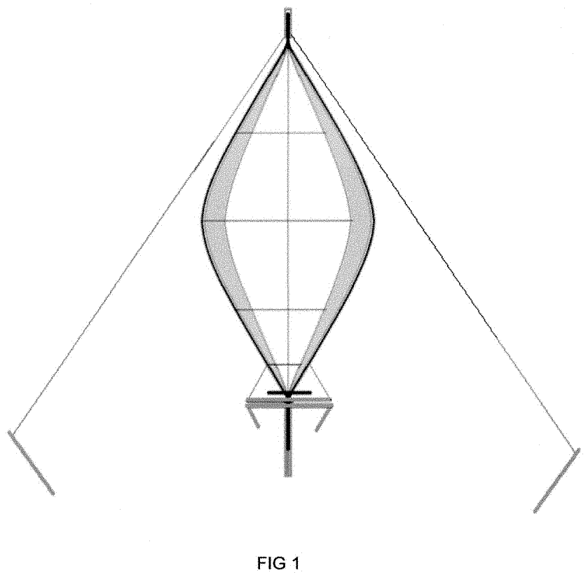

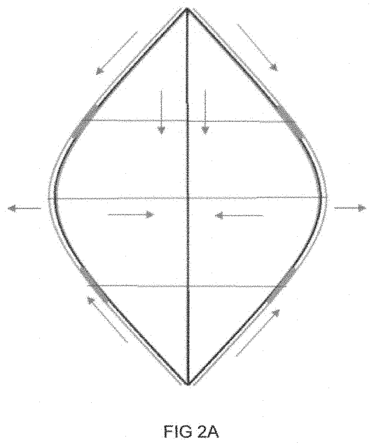

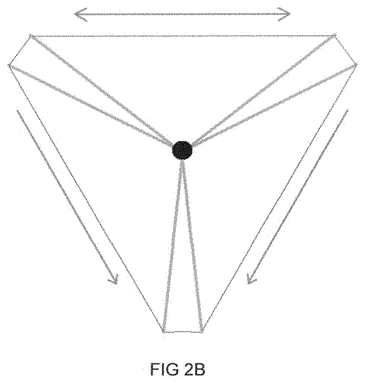

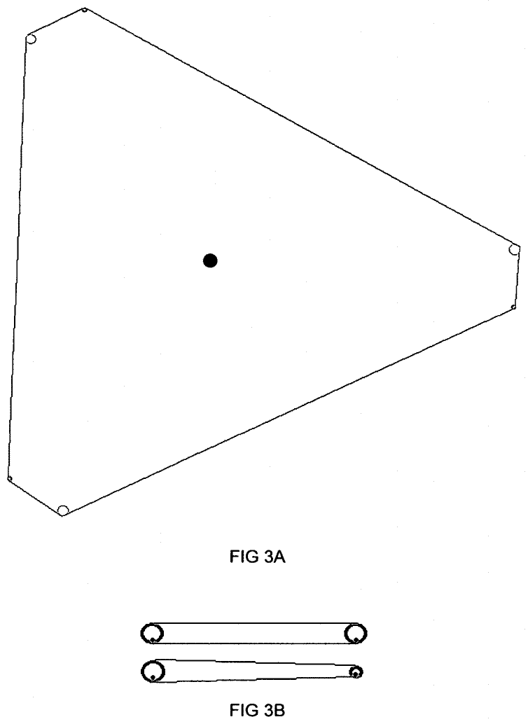

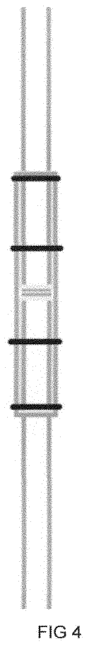

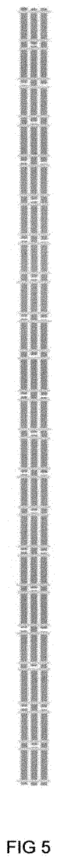

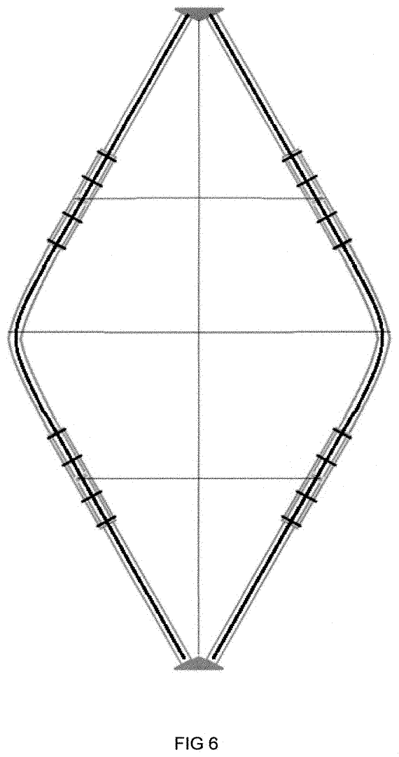

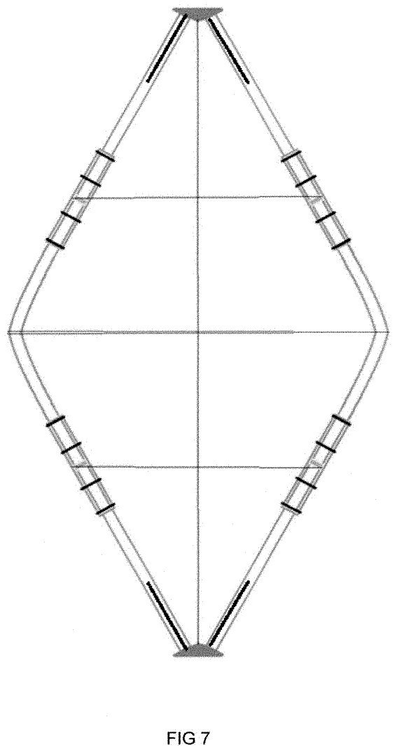

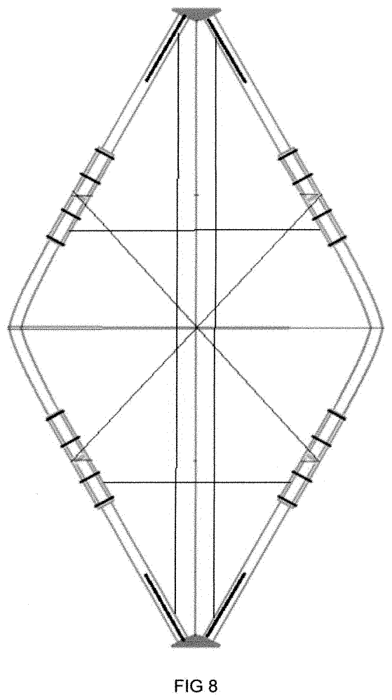

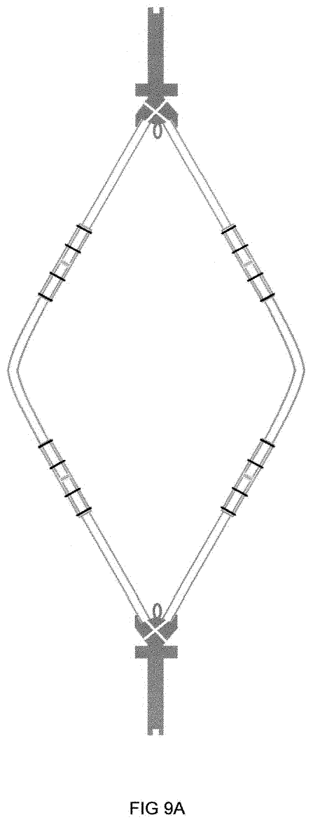

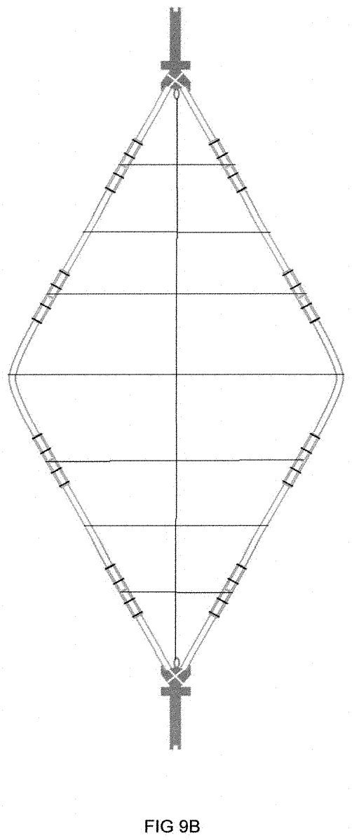

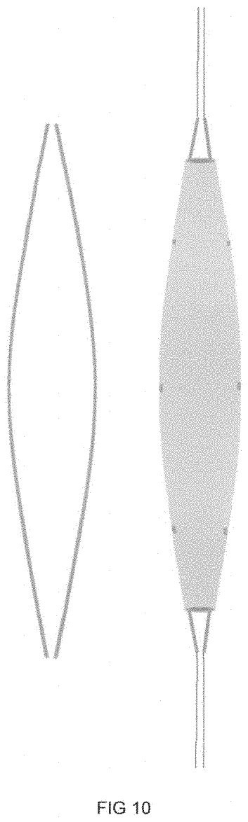

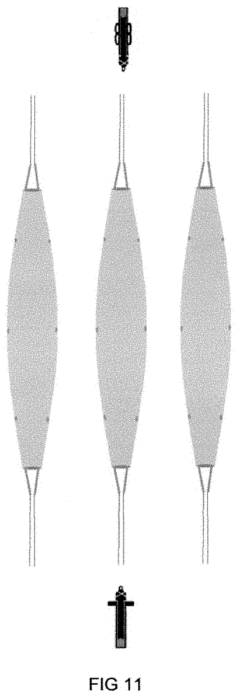

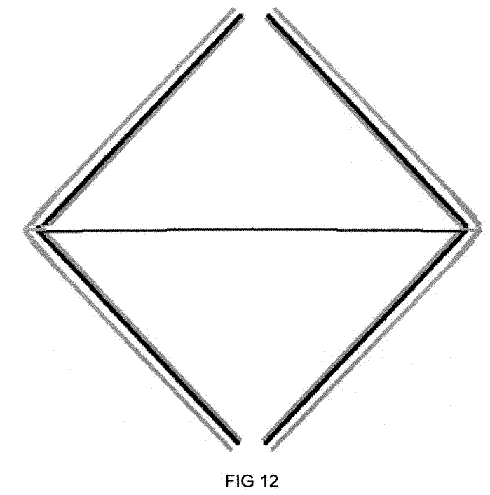

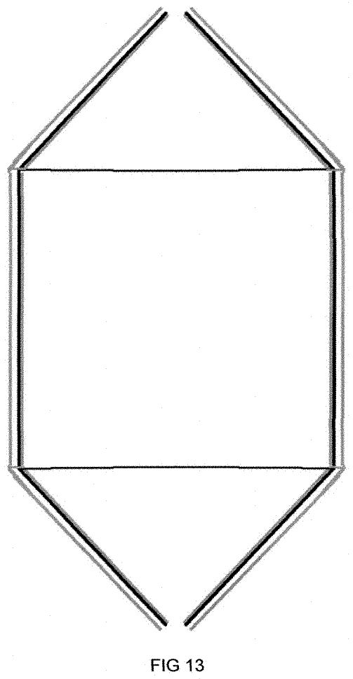

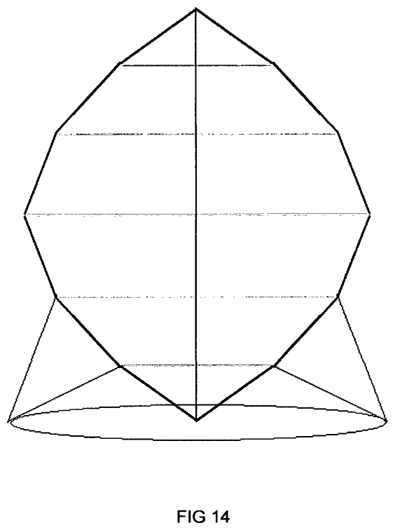

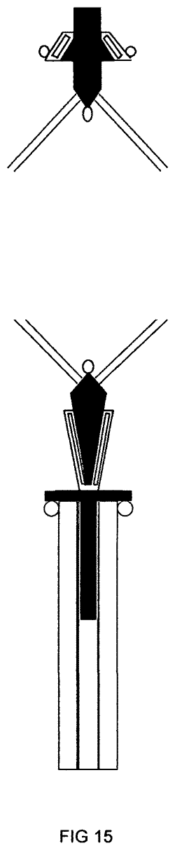

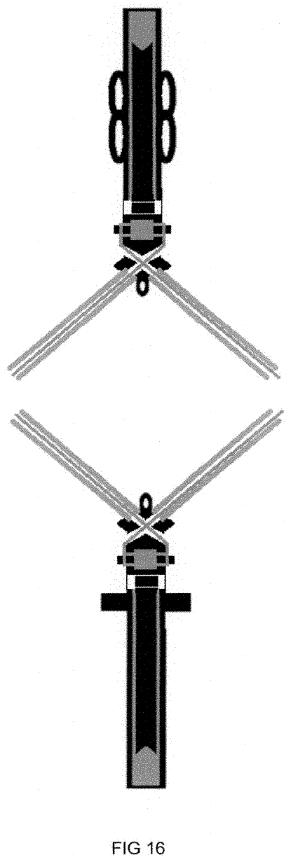

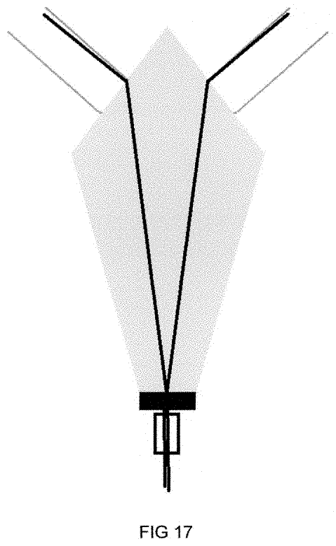

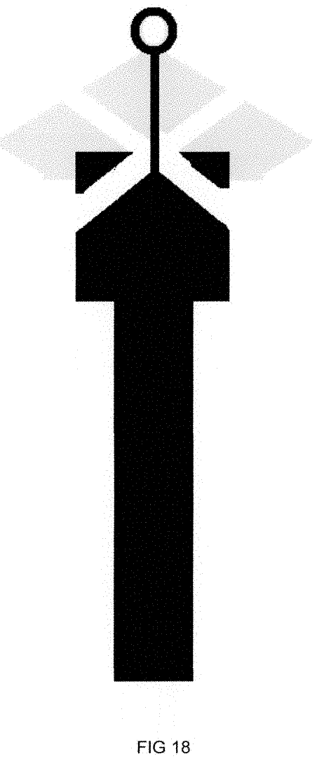

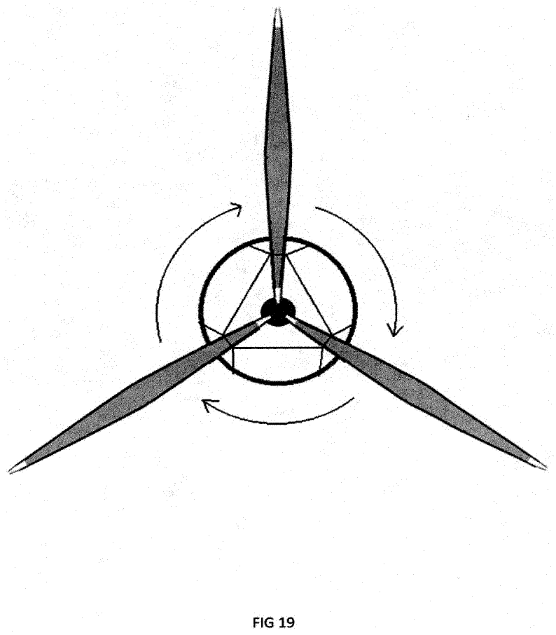

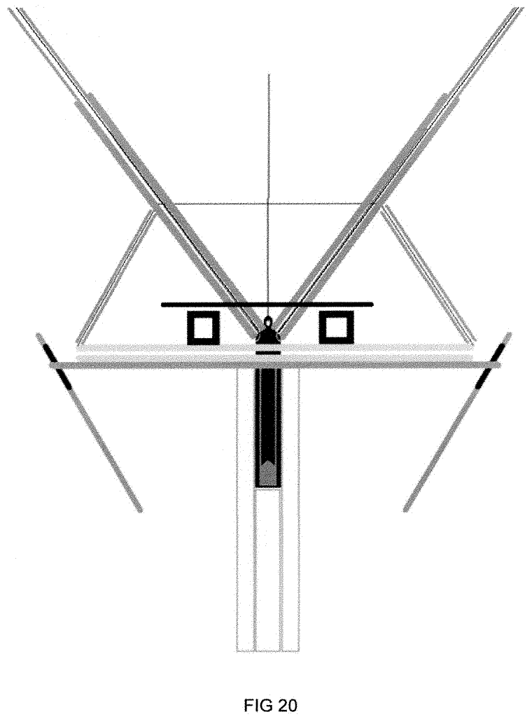

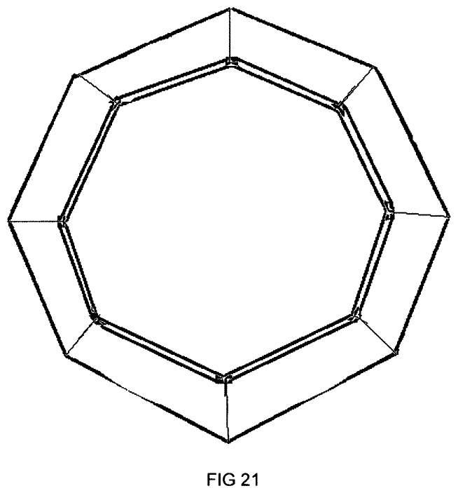

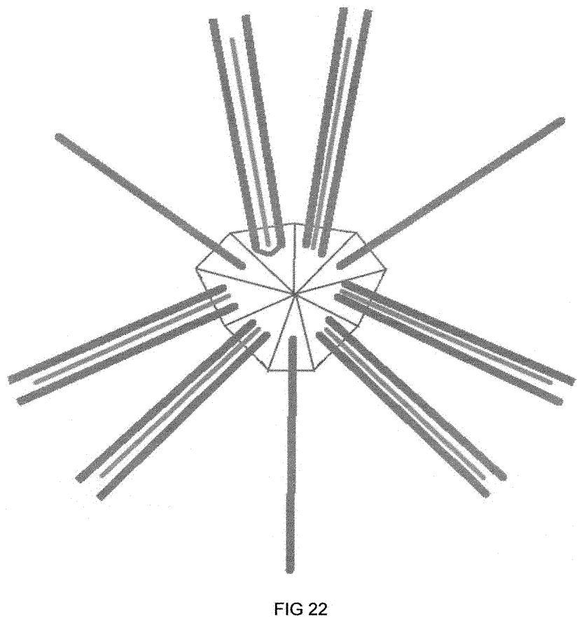

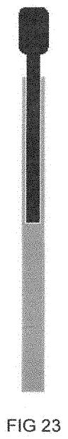

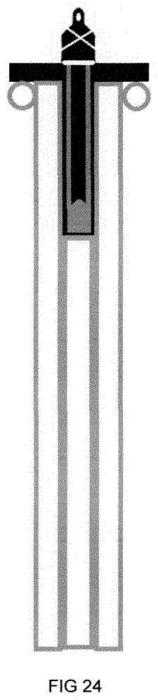

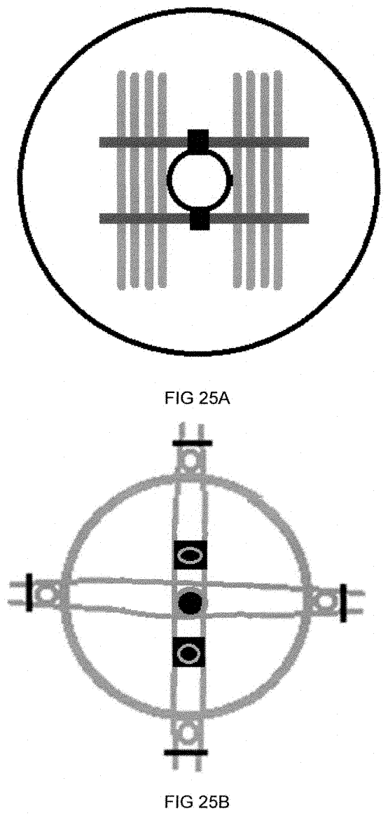

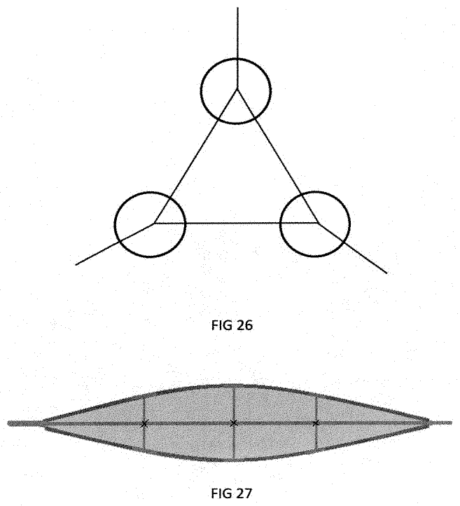

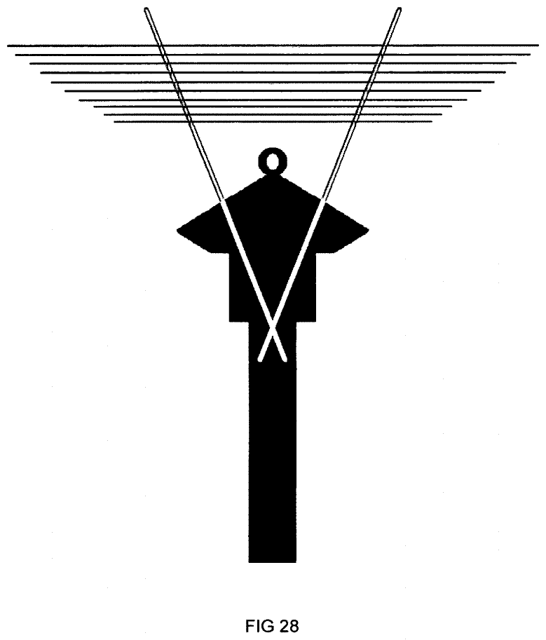

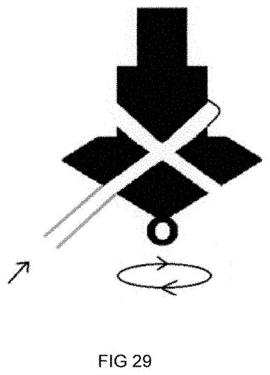

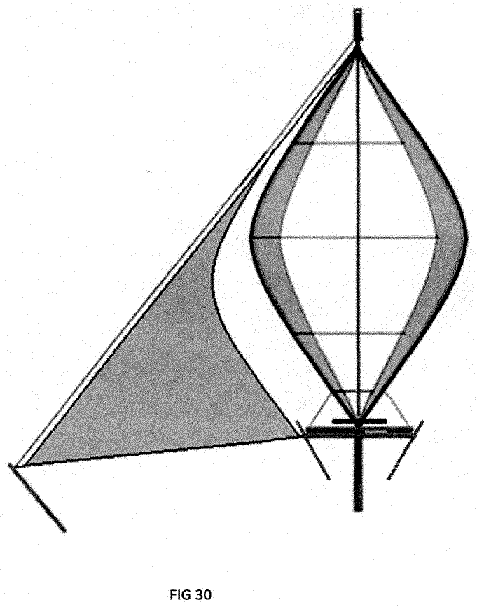

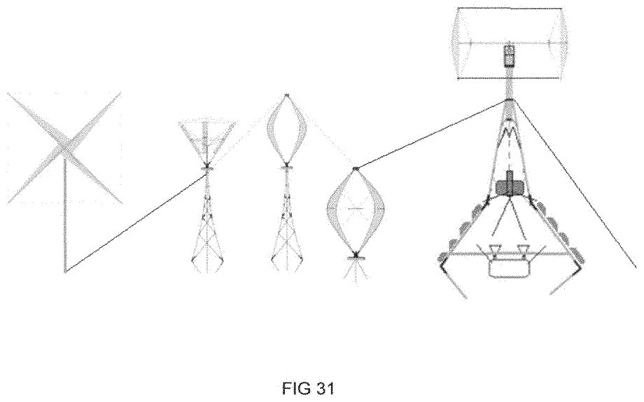

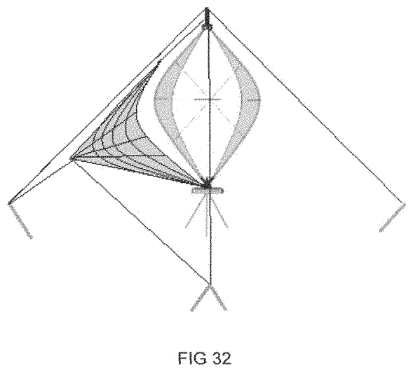

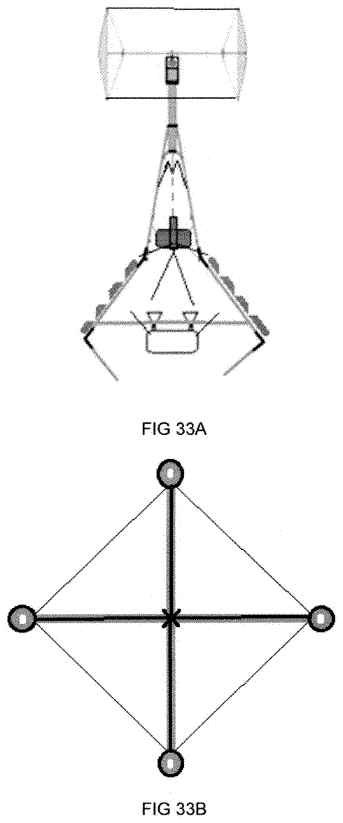

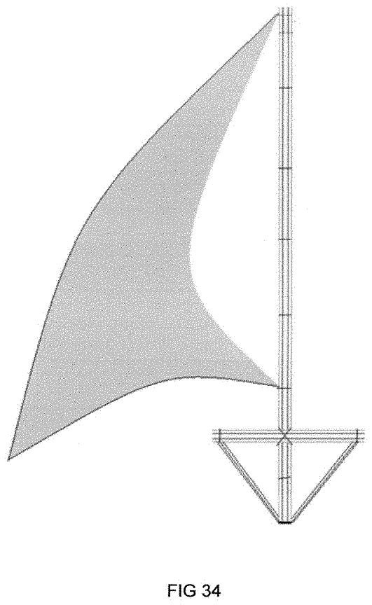

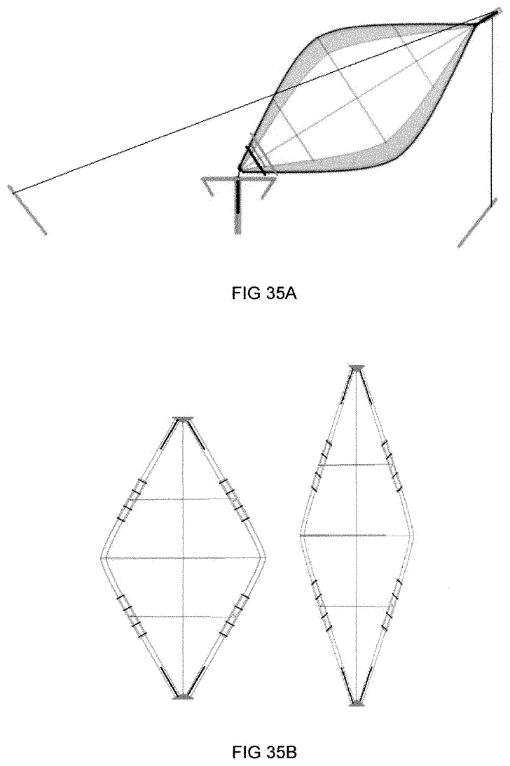

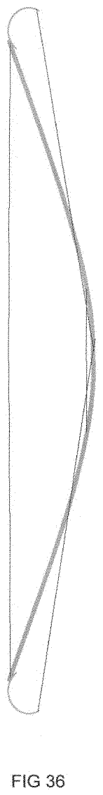

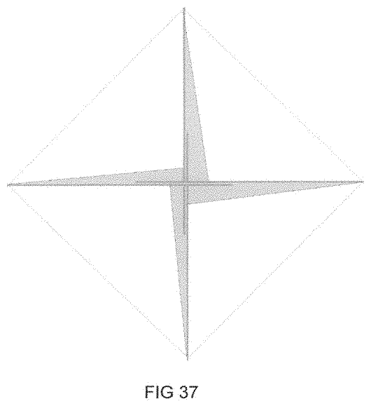

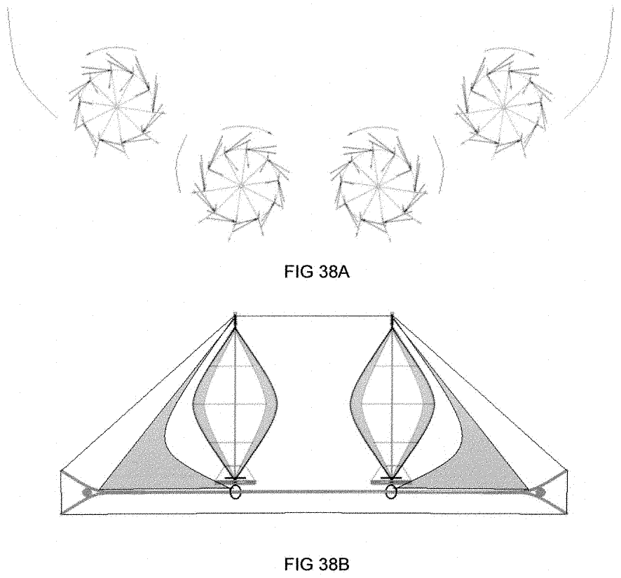

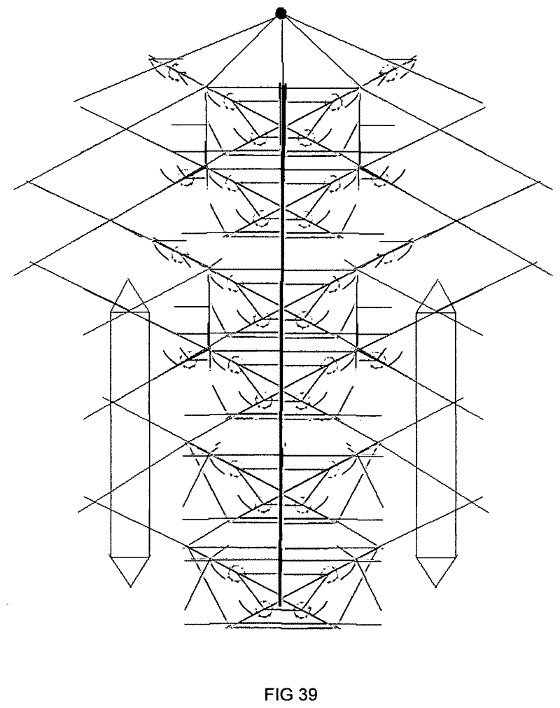

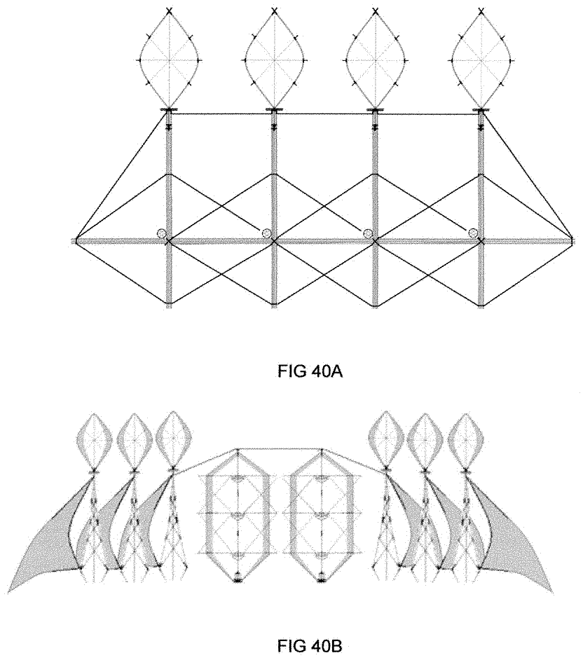

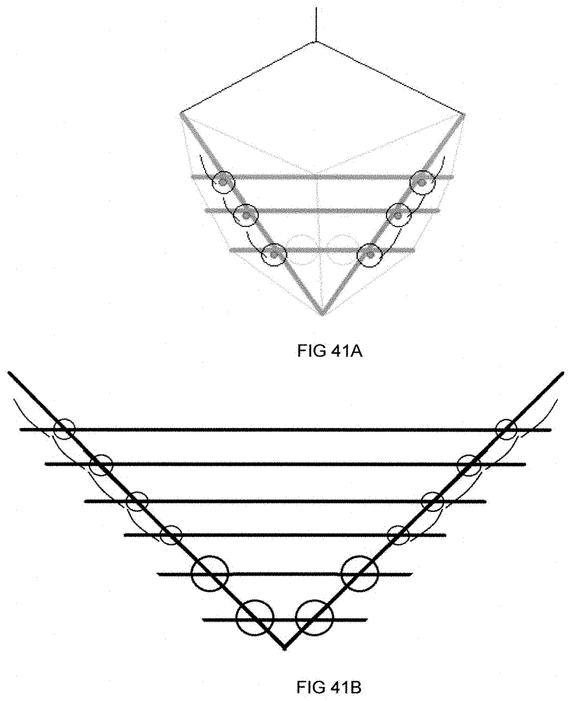

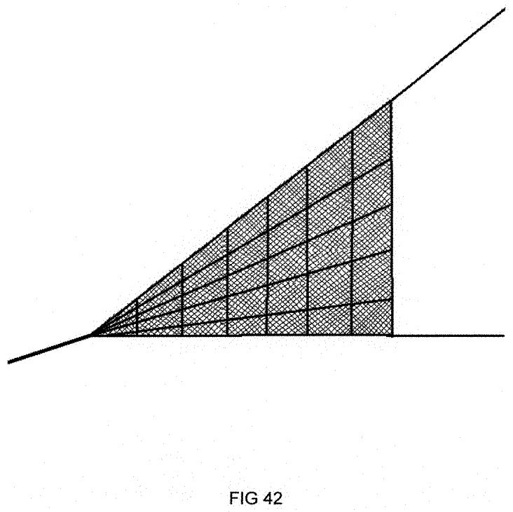

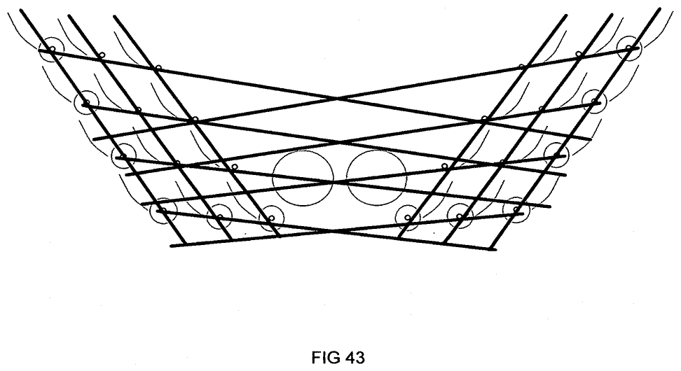

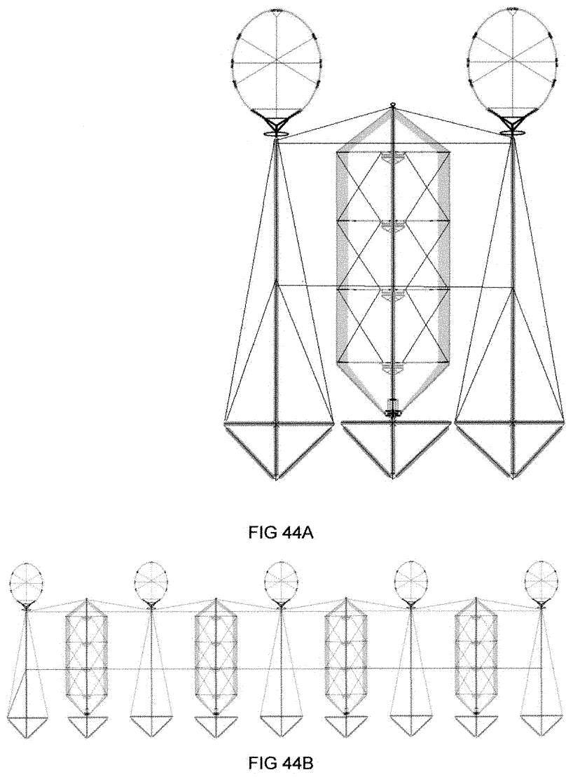

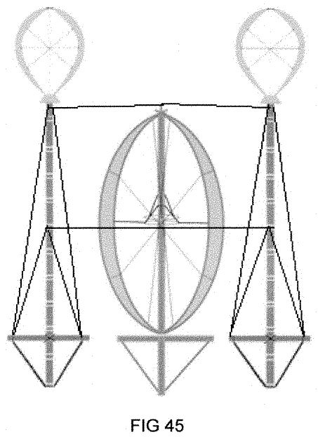

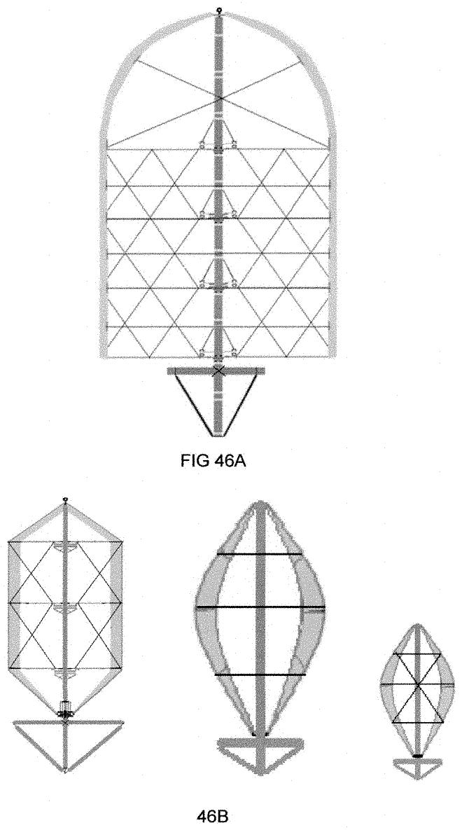

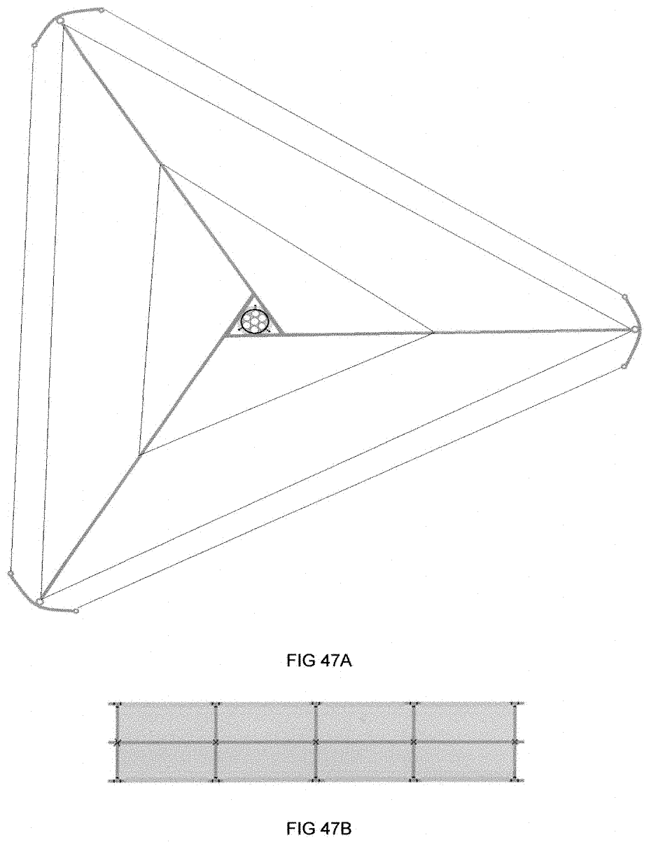

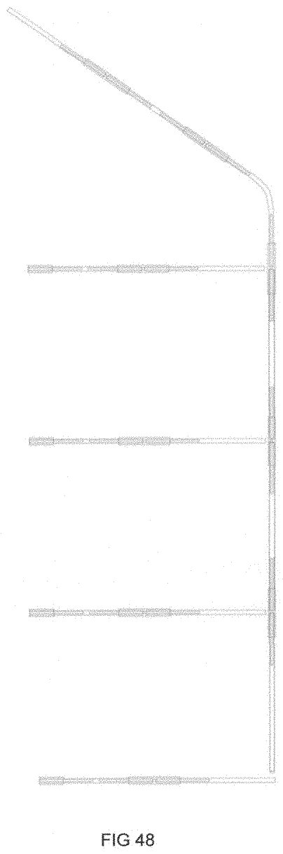

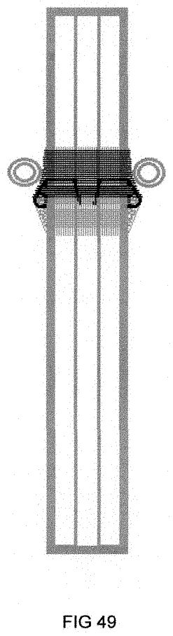

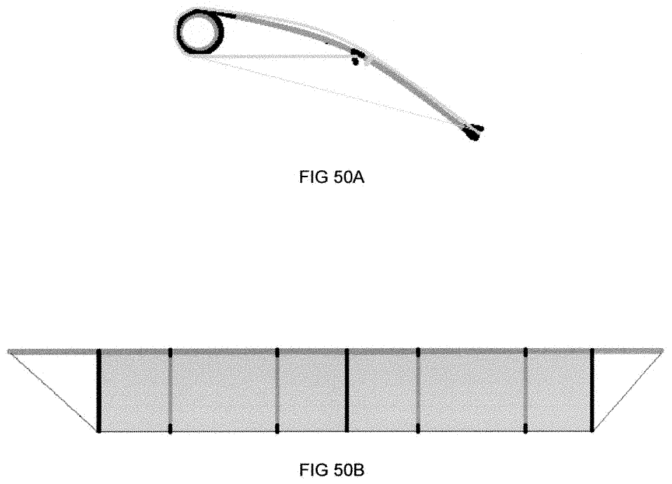

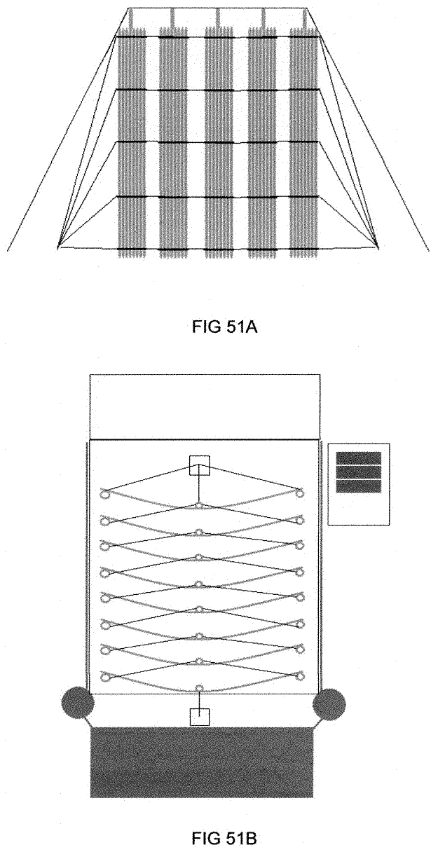

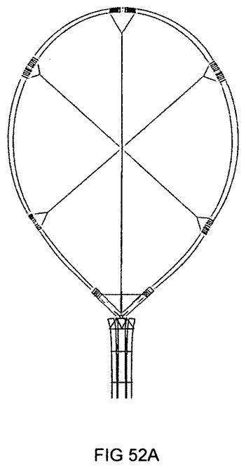

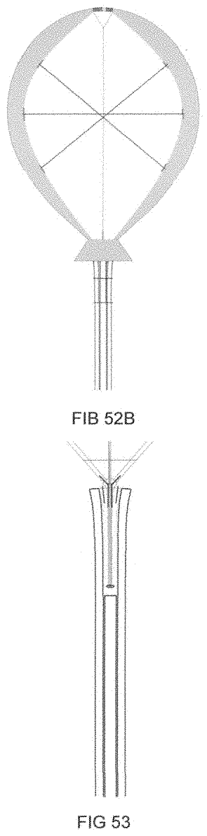

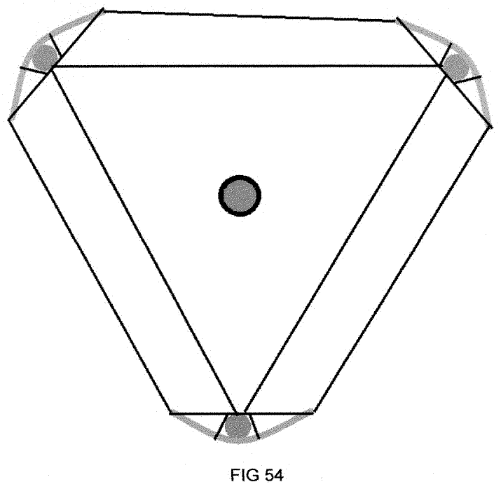

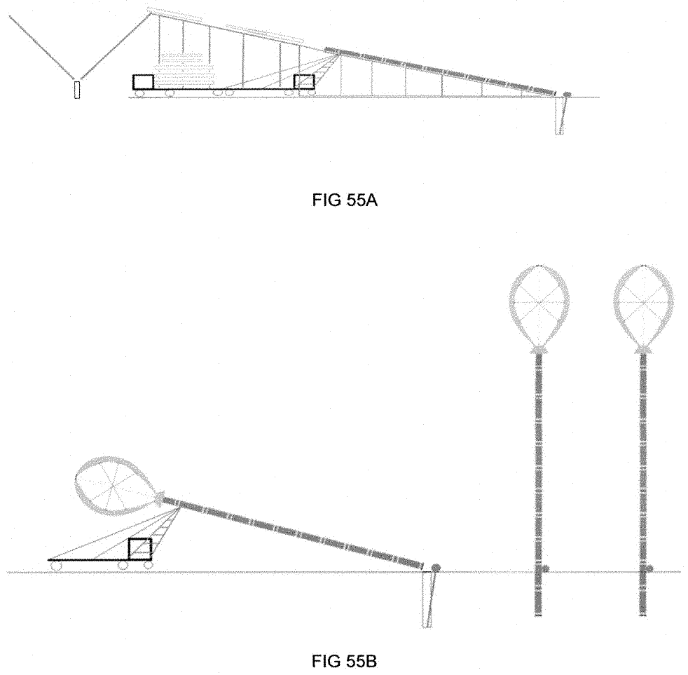

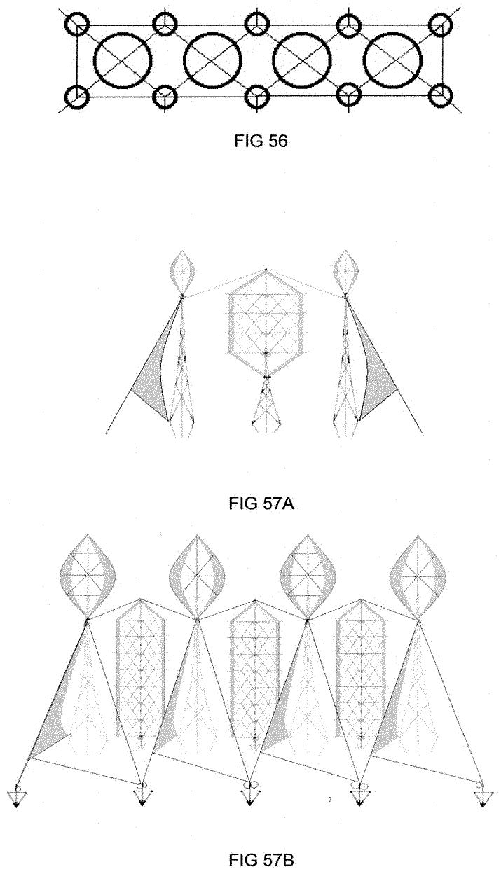

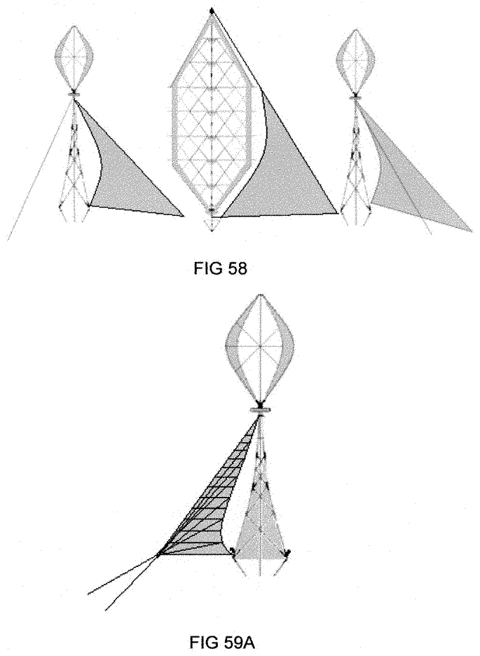

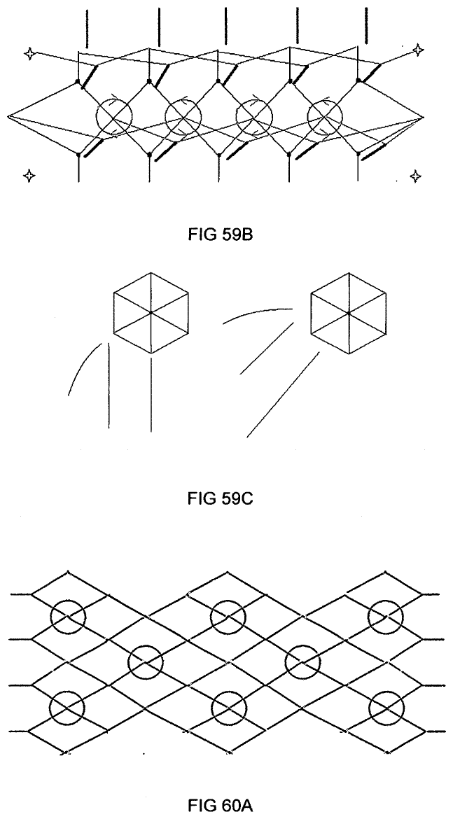

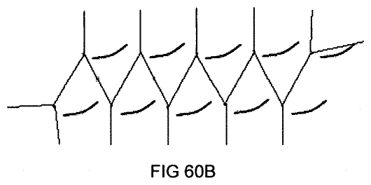

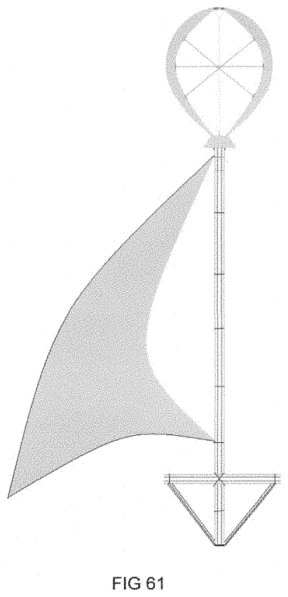

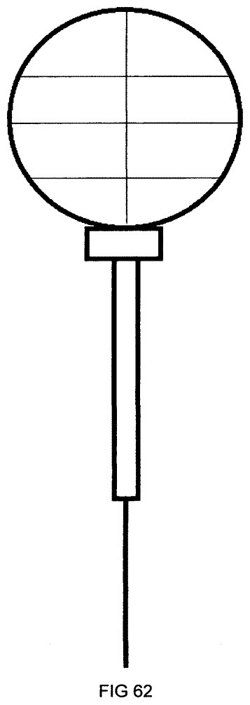

### DETAILED DESCRIPTION

A vertical axis darrieus type wind turbine that comprises more than two blades and the central tower is replaced by one or more central high tension cable that compress the turbine and cause an outward spreading of the blades; additionally the turbine can have one or more high tension cables wrapped around the circumference of the turbine such that these circumferential cables resist the spreading of the blades caused by the central high tension cables reducing turbine deformation under stress and eliminating the need for a tower. This turbine can have a top and/or bottom bearing and be directly mounted on the ground, tower top, rooftop, or floating platform. Can have a central high-tension cable that is adjustable through a winch system and/or high tension circumference cables that are adjustable through winches and/or pulleys these adjustable parts can be separate or can be controlled and linked by pulleys with the central cable continuing along the lengths of the blades to pulleys at the circumference cable points allowing the system to collapse and adjust diameter on command. The turbine can have wind turbine blades that comprise blade shaped sleeves made from an architectural fabric or fiber resin composite with one or more whole bamboo poles inserted end to end the length of the sleeve and reinforcing sleeve(s) made from a rigid and/or flexible material wrapped around the points that the pole ends meet and cable(s) threaded through the inside length of the pole(s) end to end with the cables attached at each end to a bearing or/or to another similar wind turbine blade or cable. These can be the blades of a three or more bladed Darrieus type vertical axis wind turbine with a central compression high tension cable replacing a tower and high-tension cables wrapped around the circumference of the turbine. These blades can be composed without cables threaded through the interior length further comprising the blades of a three or more bladed Darrieus type vertical axis wind turbine and three or more-pronged end piece(s) inserted into the bamboo poles at the top and bottom of the turbine as an attachment system. The blades can be comprised with central compression cables replacing a tower and/or cables wrapped around the circumference of the turbine. There is an attachment piece for wind turbine blades comprised of a 9-sided pyramidic such that sides corresponding to the number of blades or bamboo poles have holes drilled through it for a cable from a wind turbine blade to pass through and tie off around the attachment so the blades poles can rest flush against the attachment; the angles and side lengths of the pyramidic attachment. The attachment piece can be part of a bearing with enlarged holes for the cables and an aerodynamic attachment on the exiting end of the hole so that when the turbine spins it acts as a pump to draw air through the holes to cool wind turbine bearings attached to the attachment. As part of a bearing the attachment piece can have holes drilled in it for heat sticks leading to a heat sink. Additionally the invention is a wind turbine Generator comprising a ring with magnets and/or windings attached and hung from the blades of a vertical axis wind turbine and a ring with coils and/or windings attached to the ground, foundation, tower, or platform through piling or other attachment method so that the hanging ring is just above the lower ring and as the turbine spins the hung ring moves magnetic flux through the staked ring. The generator referenced can have the rings made of bamboo composites and whole bamboo pole segments with cables threaded through the interior. Additionally the invention comprises a pole to be used as a wind turbine tower or foundation comprised of bamboo poles joined lengthwise using an insert and bundled with outer lengths of bamboo but offset so that the middles of poles in the bundle are offset from the joints of the other lengths to reinforce the bundles like a splint. This pole can have a space in the center of the end for a wind turbine bearing to be placed. The invention includes a female piece bearing for the bottom of a vertical axis wind turbine comprises a piece with holes drilled in it for heat sticks and lips at the extends from the top of the piece to rest on foundation elements to displace the weight of the turbine. Additionally, the invention includes a wind turbine brake comprises a conductive plate nested at the center near the bottom of and between tower-less vertical axis wind turbine blades; with electromagnets attached to the foundation, platform, tower, or staked directly to the ground. There is also a method for reducing the number of peripheral guide wire anchors for a darrieus type turbine by arranging multiple turbines together such that the some of the top guide wires can be directly attached to adjacent wind turbine tops and others directly to anchors on the ground. Furthermore, it includes a method of reducing the downstream pressure of a wind turbine by using a jib type sail structure to constrict flow; the sail can be attached directly to a tower-less vertical axis wind turbine or to a tower. The jib sail structure with the point of the sail structure at the bottom farthest from the turbine having two cables attached each to an electric winch attached to a ground anchor that can adjust the relative position of the sail structure. It includes a floating platform wind turbine platform comprising multiple vertical axis and horizontal axis turbines mounted on it in an array shaped like a wind sock so the platform self-directions into the wind and optimal position for peak power. The platform composed of bundles of bamboo poles plugged and coated in a resin and or paint to form a floating structural platform.

1) A vertical axis darrieus type wind turbine that comprises more than two blades and the central tower is replaced by one or more centrally located high tension cable that compress the turbine and cause an outward spreading of the blades; additionally the turbine can have one or more high tension cables wrapped around the circumference of the turbine such that these circumferential cables resist the spreading of the blades caused by the central high tension cables reducing turbine deformation under stress and eliminating the need for a tower. This turbine can have a top and/or bottom bearing and be directly mounted on the ground, tower top, rooftop, or floating platform.

2) The vertical axis turbine claimed in claim 1 with a central high-tension cable that is adjustable through a winch system and/or high tension circumference cables that are adjustable through winches and/or pulleys these adjustable parts can be separate or can be controlled and linked by pulleys with the central cable continuing along the lengths of the blades to pulleys at the circumference cable points allowing the system to collapse and adjust diameter on command.

3) Wind turbine blades that comprise blade shaped sleeves made from an architectural fabric, membrane, or fiber resin composite with one or more whole poles made from bamboo or cylindric polymer inserted end to end the length of the sleeve and reinforcing sleeve(s) made from a rigid and/or flexible material wrapped around the points that the pole ends meet and cable(s) threaded through the inside length of the pole(s) end to end with the cables attached at each end to a bearing or/or to another similar wind turbine blade or cable.

4) The blades claimed in claim 3 comprising the blades of a three or more bladed Darrieus type vertical axis wind turbine with a central compression high tension cable replacing a tower and high-tension cables wrapped around the circumference of the turbine.

5) The blades claimed in claim 3 without cables threaded through the interior length further comprising the blades of a three or more bladed Darrieus type vertical axis wind turbine and three or more-pronged end piece(s) inserted into the bamboo poles at the top and bottom of the turbine as an attachment system.

6) The blades and turbine claimed in claim 5 with central compression cables replacing a tower and/or cables wrapped around the circumference of the turbine.

7) An attachment piece for wind turbine blades comprised of a 9-sided pyramidic such that sides corresponding to the number of blades or bamboo poles have holes drilled through it for a cable from a wind turbine blade to pass through and tie off around the attachment so the blades poles can rest flush against the attachment; the angles and side lengths of the pyramidic attachment.

8) The attachment piece claimed in claim 7 as part of a bearing with enlarged holes for the cables and an aerodynamic attachment on the exiting end of the hole so that when the turbine spins it acts as a pump to draw air through the holes to cool wind turbine bearings attached to the attachment.

9) The attachment piece claimed in claim 7 as part of a bearing with holes drilled in it for heat sticks leading to a heat sink.

10) A wind turbine Generator comprising a ring with magnets and/or windings attached and hung from the blades of a vertical axis wind turbine and a ring with coils and/or windings attached to the ground, foundation, tower, or platform through piling or other attachment method so that the hanging ring is just above the lower ring and as the turbine spins the hung ring moves magnetic flux through the staked ring.

11) The generator claimed in claim 10 comprising the rings made of bamboo composites and whole bamboo pole segments with cables threaded through the interior.

12) A pole to be used as a wind turbine tower or foundation comprised of bamboo poles joined lengthwise using an insert and bundled with outer lengths of bamboo but offset so that the middles of poles in the bundle are offset from the joints of the other lengths to reinforce the bundles like a splint.

13) The pole claimed in claim 12 with a space in the center of the end for a wind turbine bearing to be placed.

14) A female piece bearing for the bottom of a vertical axis wind turbine comprises a piece with holes drilled in it for heat sticks and lips at the extends from the top of the piece to rest on foundation elements to displace the weight of the turbine.

15) A wind turbine brake comprises a conductive plate nested at the center near the bottom of and between tower-less vertical axis wind turbine blades; with electromagnets attached to the foundation, platform, tower, or staked directly to the ground.

16) A method of reducing the number of peripheral guide wire anchors for a darrieus type turbine by arranging multiple turbines together such that the some of the top guide wires can be directly attached to adjacent wind turbine tops and others directly to anchors on the ground.

17) A method of reducing the downstream pressure of a wind turbine by using a jib type sail structure to constrict flow; the sail can be attached directly to a tower-less vertical axis wind turbine or to a tower.

18) The jib sail structure claimed in claim 17 with the point of the sail structure at the bottom farthest from the turbine having two cables attached each to an electric winch attached to a ground anchor that can adjust the relative position of the sail structure.

19) Floating platform wind turbine platform comprising multiple vertical axis and horizontal axis turbines mounted on it in an array shaped like a wind sock so the platform self-directions into the wind and optimal position for peak power.

20) The platform claimed in claim 19 composed of bundles of bamboo poles plugged and coated in a resin and or paint to form a floating structural platform.
